(19) United States
(12) Patent Application Publication
(10) Pub. No.: US 2008/0143328 A1
(43) Pub. Date: Jun. 19, 2008

(54) Method and Device for Measuring the Magnetic Properties of Documents

(76) Inventors: Klaus Thierauf, Munchen (DE); Helmut Pradel, Munchen (DE)

Correspondence Address: BACON & THOMAS, PLLC, 625 SLATERS LANE, FOURTH FLOOR, ALEXANDRIA, VA, 22314, US

(21) Appl. No.: 11/885,188

(22) PCT Filed: Feb. 24, 2006
(86) PCT No.: PCT/EP2006/001702

§ 371 Date: Nov. 14, 2007

(30) Foreign Application Priority Data
Feb. 28, 2005 (DE) 10 2005 008 967.4

(51) Int. Cl. G07D 7/04; G01N 27/72

(52) U.S. Cl. 324/239

(57) ABSTRACT

The present invention relates to a method and an apparatus for measuring magnetic properties of a document (5) and to a measuring head (12) suitable therefor for measuring magnetic field changes. The apparatus comprises a device (2, 3) for generating an electromagnetic alternating field, a measuring element (6) and a lock-in amplifier (7). The measuring element (6) is so adapted that it converts an electrical input signal of the measuring element (6) into an electrical output signal in dependence on changes of the magnetic field when the document (5) with magnetic properties is brought into the magnetic field. The measuring element (6) used is preferably as a GMR or SDT element which changes its electrical resistance comparatively strongly upon even small changes of the electromagnetic alternating field. The measuring head (12) for use in the apparatus comprises a printed circuit board (13) with coils (14) disposed thereon and a GMR or SDT element (6).

The present invention relates to a method and an apparatus for measuring magnetic properties of documents, in particular bank notes, and to a measuring head suitable therefor for measuring magnetic field changes.

Methods and apparatuses for measuring magnetic properties of documents are known in which a magnetic field is generated by means of a permanent magnet. In this regard, DE 40 22 739 A1 describes an apparatus with a magnetic circuit, consisting of soft magnetic and permanent magnetic material, the static magnetic field generated by the permanent magnetic material penetrating the magnetic circuit. The magnetic circuit generates a stray field which undergoes changes when a test object with magnetic particles is moved into the stray field area. Said changes are detected by means of a coil by a voltage being induced in the coil due to the changes. With this measuring principle, the change to be measured can be noticeably influenced by even small external influences, which additionally impedes the detection of the change.

DE 39 31 828 A1 describes a method and an apparatus for reading a bar code which consists of a multiplicity of adjacent stripes made of ferromagnetic material. A high-frequency electromagnetic alternating field is generated above the bar code so that a change of the electromagnetic alternating field is caused by the ferromagnetic stripes. By means of sensor coils which induce a changing voltage in accordance with the changes, inductive recognition of the bar code is possible. The induced voltage can be disturbed by external influences, however, so that the measured changes are distorted. To eliminate such disturbances from the measured signal, the measured signal is additionally supplied to a synchronous demodulator and a low-pass filter. The measured signal is multiplied in the synchronous demodulator by a reference signal of the same frequency and if possible the same phase. High-frequency components are subsequently filtered out in the low-pass filter to obtain an adjusted signal containing substantially only the measured changes. This type of signal processing is sometimes also referred to as the lock-in principle.

A disadvantage of the above-mentioned inductive methods is that small changes of the electromagnetic alternating field, for example if only a very low concentration of ferromagnetic material is provided in the stripes or the exciting magnetic field is weak, are very difficult or impossible to recognize. The primary reason for this is that there are frequently interference fields in the measuring site that are superimposed on the measurement in such a way that an additional slight change of the electromagnetic alternating field by a document to be measured is no longer reliably detectable by conventional means.

The problem of the invention is to specify a solution permitting reliable classification even of documents having small amounts of magnetic particles.

This problem is solved by the features of the independent claims. Advantageous embodiments and developments of the invention are stated in dependent claims.

According to the invention, a document to be checked containing magnetic particles is brought into an electromagnetic alternating field, the change of the alternating field being measured using a measuring element which converts an electrical input signal of the measuring element into an electrical output signal in dependence on the electromagnetic alternating field applied to the measuring element. Compared with the purely inductive measurement procedures known from the prior art, measurement with such a measuring element has the advantage of being time-independent, since the change of electrical resistance in a given test document depends only and directly on the strength of the applied magnetic field. In contrast, purely inductive methods are (also) time-dependent since a voltage is induced in the coil only when the magnetic flux penetrating the coil is subject to a temporal or spatial change. The invention therefore permits a static measurement or a measurement at slow document feed, thereby making the measurement more exact.

Preferably, a measuring element is used wherein the electrical resistance of the measuring element changes in dependence on the changes of the electromagnetic alternating field. The measuring element can for example be supplied with a current so that an alternating voltage drops across the measuring element. When the electrical resistance of the measuring element changes due to the change of the alternating field, the amplitude of the applied alternating voltage also changes. This detected amplitude change can then be processed further accordingly.

Particularly preferably, the measuring element used is a magnetoresistive element. Preferably, this is a giant magnetoresistance (GMR) element. In GMR elements the change of an external magnetic field applied to the element causes a change in its electrical resistance. This enables the GMR element to convert magnetically coded information into an electrical signal by the amplitude of the output signal of the GMR element changing in dependence on the resistance value of the GMR element. It is a special advantage of such a measuring element that even small changes of the electromagnetic alternating field can be ascertained, since GMR elements have the property of changing their electrical resistance comparatively strongly upon even small magnetic field changes. Thus, GMR elements have increased sensitivity compared to other measuring elements or sensors. It is therefore possible to detect even weakly doped documents that cause only a small field change. Due to the increased sensitivity, authentic bank notes can furthermore be better distinguished from forgeries whose magnetic particle content differs only slightly from that of authentic bank notes. Also, the inventive apparatus can be used variably and has little influence on adjacent systems, since the GMR sensor can also work at accordingly low field strengths due to its high sensitivity.

If the signal generator generates a high-frequency signal, a further advantage of the GMR element can be utilized. The disturbing 1/f noise of the GMR element occurs in a GMR element only in the low-frequency range and disappears above a certain frequency, leaving only a lower, white noise component. In this way a substantially higher signal-to-noise ratio is obtained. “High-frequency” means in this connection a frequency of more than 1 kHz, preferably over 10 kHz. In tests, magnetically soft and hard particles were detected with the inventive apparatus at a reference frequency of 7 kHz. Due to the properties of the GMR element an improvement in the measurement results is to be expected at a reference frequency between 10 kHz and 50 kHz. The structure of GMR elements and their operation are described in detail for example in EP 0 793 808 B1.

It is provided according to the invention to process the output signal of the measuring element by means of a lock-in amplifier. If the measuring element used is for example a GMR element, even very small changes of the electromagnetic alternating field can be detected by the GMR element. Since these changes result in comparatively small changes of the output signal of the GMR element, the output signal can be amplified in the lock-in amplifier for further processing. For this purpose the GMR signal, possibly after being amplified, is multiplied by a normalized reference signal of the same frequency in a synchronous demodulator. The signal generator with which the electrical input signal for the GMR element is generated is preferably also used for generating the reference signal. Since the frequency of the GMR output signal always corresponds to that of the GMR input signal independently of any effect of a magnetic field, the common signal generator can be used to generate same-frequency signals for the lock-in amplification. To make sure that the reference signal is multiplied by the GMR output signal in phase, it is possible to use for example a phase-locked loop (PLL) for phase-locked regeneration of the reference signal.

The output signal of the synchronous demodulator subsequently passes a low-pass filter. The low-pass filter with a certain cutoff frequency removes the disturbing high-frequency components. After the low-pass filter has filtered out the high-frequency components, the result obtained is an adjusted signal which is proportional to the amplitude of the GMR output signal.

Since the electrical output signal of the measuring element is multiplied by a system-inherent reference signal of the same frequency and phase, the reference signal used preferably being the input signal for the measuring element, even small changes of the electromagnetic alternating field which can be detected and verified by the measuring element can be processed with high precision. An additional evaluation electronics can be used to evaluate the measurements accordingly. In particular upon comparison measurements, the signal measured and processed by the lock-in amplifier must be compared with a given signal and/or other measured signals and evaluated. This comparison and the evaluation are then effected in the evaluation electronics, whereby the evaluation electronics can for example already comprise the lock-in amplifier.

The inventive apparatus can be used particularly advantageously for measuring or recognizing magnetically soft particles in documents. The magnetically soft particles are continually reversed magnetically by the electromagnetic alternating field. The particles bundle the magnetic field lines, thereby strengthening the magnetic field. An advantage of magnetically soft materials is that they are readily magnetizable and can therefore also strengthen weak magnetic fields. On the other hand, magnetically soft materials only slightly change the electromagnetic alternating field, unlike magnetically hard materials, and thus provide only a weak signal to be measured. With conventional measuring devices they are therefore not always reliably detectable. The invention also permits such materials to be reliably detected in documents, in particular when a GMR element and/or a lock-in amplifier is used.

In one embodiment of the invention, the electromagnetic alternating field is generated by high-frequency bursts of a burst generator. Burst excitation is understood to be the intermittent, bursty transmission of a signal. Burst excitation permits a particularly high current load on the field generating coil due to the lower average dissipation rate. The average dissipation rate is lower in burst excitation since there is no power dissipation in the burst pauses. If bursts with high current intensity are used, the magnetic particles of the document are magnetized accordingly more strongly and consequently cause a stronger change of the alternating field. This causes an accordingly stronger change in the electrical output quantity of the measuring element, i.e. its electrical resistance in the case of a GMR element, thereby making the measurement of the magnetic properties of the document more exact.

The inventive apparatus also makes it possible to distinguish magnetically hard and soft particles. Magnetically hard materials have a considerably “broader” hysteresis loop than magnetically soft materials. That is, magnetically hard materials have a higher remanence, so that considerably higher coercive field strength must be applied in comparison with magnetically soft materials to make this remanence disappear. Consequently, magnetically hard materials have a higher remanence in the absence of an external magnetic field, i.e. in the absence of current on the exciting coil, which manifests itself upon measurement with the measuring element in a greater change of the electrical resistance of the measuring element. Due to these different properties of magnetically hard and soft materials, it can be ascertained what kind of material is involved by a comparison of different measurements. For example, the particles can be premagnetized in a premagnetization section. Measurements can then be carried out at times when the coil does not generate an electromagnetic alternating field. It is particularly preferable to use burst excitation as the excitation for the exciting coil, since in the no-pulse periods between the recurring pulse bursts when the exciting coil does not carry current, the materials to be measured are premagnetized and can be measured.

A measuring head for measuring changes of a magnetic field which can be advantageously used with the present invention comprises at least one exciting coil for generating a magnetic field and a giant magnetoresistance (GMR) element for measuring changes of the magnetic field, the at least one exciting coil and the GMR element being disposed on a printed circuit board. The integration of the coil and the GMR element on a printed circuit board is inexpensive and is therefore advantageous compared to known measuring heads. An evaluation electronics suitable for evaluating changes of the magnetic field can also be disposed inexpensively on the printed circuit board. The evaluation electronics can comprise the lock-in amplifier.

The printed circuit board is preferably disposed between two elements, for example made of ferrite material, which concentrate the flux of the magnetic field generated by the at least one exciting coil. Furthermore, the arrangement of the exciting coil on the printed circuit board is executed inexpensively as a multilayer printed coil.

A further advantage of the inventive measuring head is the space-saving structure. This makes it possible for example to dispose a multiplicity of measuring heads side by side in the above-described inventive apparatus to permit measurements to be carried out at the same time along a multiplicity of measuring tracks across the whole width of a document to be examined.

According to a further idea of the present invention, the magnetoresistive elements used are not GMR elements but alternatively so-called “spin-dependent tunneling” (SDT) elements. Said SDT elements have a higher sensitivity than GMR elements by a factor of 10-20 and are therefore particularly preferable.

It should be emphasized that the features of the dependent claims and of the embodiments stated in the following description, in combination or independently of each other and in particular of the subject matter of the main claims, e.g. in magnetic measurement procedures without the use of lock-in amplifiers, describe further basic ideas and can be advantageously used.

Further features and advantages of the invention will result from the following description of various inventive embodiments and alternatives in connection with the accompanying drawings. These show:

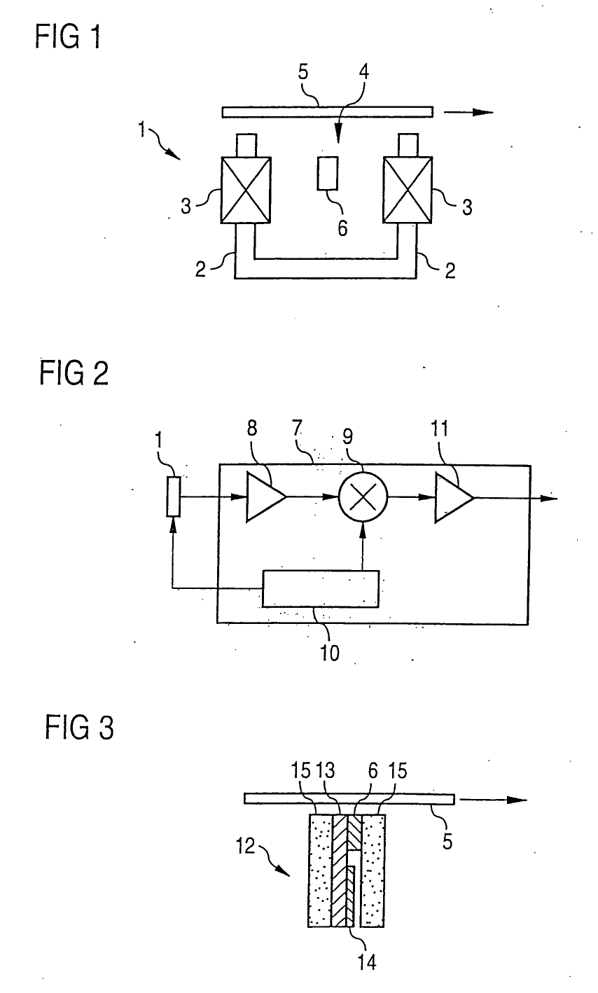

FIG. 1 a measuring head;

FIG. 2 a schematic view of an inventive apparatus with the measuring head from FIG. 1; and

FIG. 3 a preferred embodiment of a measuring head in cross section.

FIG. 1 shows a measuring head 1 for use in an inventive apparatus. One coil 3 is disposed on each of two parallel coil cores 2 which are connected to each other at one end. When the coils 3 are supplied with current they generate a magnetic field. An alternating current is used here so that an electromagnetic alternating field forms on the measuring head 1. The coil cores 2 are connected to each other only at one end so that an air-gap 4 forms between the free ends of the coil cores 2. A magnetic stray field thereby forms at the free ends of the coil cores 2. A document 5 with magnetically soft particles, for example a bank note whose ink in a printed image is provided with magnetically soft particles, is moved past the air-gap 4 of the inventive apparatus such that the stray field of the electromagnetic alternating field acts on the magnetically soft particles. The flux density in the stray field area is thus increased by the magnetically soft particles in the document 5.

A measuring element 6 which detects a corresponding change of the electromagnetic alternating field is provided between the coils 3. The measuring element 6 can be for example a GMR element which changes its electrical properties when a magnetic field is applied. The GMR element is subject to a signal whose amplitude changes according to the change of the magnetic field. The further processing of the amplitude-modulated GMR output signal will be described hereinafter with reference to FIG. 2. The GMR element is preferably disposed such that the magnetic field, which is generated for example by burst excitation of the two coils 3, is disposed perpendicular to the sensitive axis of the GMR element. This avoids overdriving of the GMR element. The GMR element is insensitive to magnetic fields perpendicular to its principal sensitivity axis.

As mentioned above, a “spin-dependent tunneling” (SDT) element can also preferably be used, due to the higher measuring sensitivity, in addition or as an alternative to the GMR elements in this and all other embodiments.

If such a measuring head 1 is to detect the total width of the test object, the magnetic field must be dimensioned accordingly strongly because of the large air-gap. For example, an excitation burst of high current intensity can be passed through the coils for this purpose. However, it is also possible to dispose a plurality of small measuring heads side by side.

FIG. 2 shows schematically an embodiment of the inventive apparatus. In addition to the measuring head 1 from FIG. 1, a lock-in amplifier 7 with at least some of its elements is shown. The output signal of the GMR element is first pre-amplified by means of an amplifier 8 in the shown embodiment of the lock-in amplifier 7. The preamplified signal is subsequently supplied to a synchronous demodulator 9 whose operation has been described above. The synchronous demodulator 9 is furthermore supplied a reference signal which must have the same frequency as the pre-amplified signal in order for the lock-in amplifier 7 to provide the desired result. Said reference signal is generated in a reference generator 10 and is furthermore used in the shown embodiment for the electrical supply of the measuring head 1, in particular the GMR element 6 with an input signal and the two coils 3 with an exciting signal.

Since conventional lock-in amplifiers are suitable only for processing analog signals, the reference signal can be for example an alternating current signal. The changes of the electromagnetic alternating field which change the electrical resistance of the GMR element 6 cause a change in the amplitude of the voltage dropping across the GMR element 6. This alternating current signal with changing amplitude is made available to the lock-in amplifier 7 as the output signal of the GMR element. After the preamplified GMR output signal has been multiplied by the same-frequency reference signal in the synchronous demodulator 9, a low-pass filter 11 filters out spurious high-frequency components of the signal, so that a signal is obtained that is proportional to the signal amplitude of the GMR output signal.

FIG. 3 shows an embodiment of a preferred measuring head 12 in cross section. Multilayer printed coils 14 for generating an electromagnetic alternating field and a giant magnetoresistance element 6 for measuring changes of the alternating field are disposed on a printed circuit board 13. The printed circuit board 13 itself is disposed between two elements 15 which concentrate the flux of the magnetic field generated by the coils in the plane of the GMR element 6. Said two elements 15 are made for example of a ferrite material which is also suitable for use in conventional coil cores. As shown in FIG. 3, the document is moved transversely to the vertically disposed measuring head 12.

1. A method for measuring magnetic properties of a document comprising the following steps:
generating an electromagnetic alternating field,
bringing a document into the electromagnetic alternating field,
detecting changes of the electromagnetic alternating field while the document is located in the electrical alternating field, by means of a measuring element which converts an electrical input signal into an electrical output signal in dependence on the electromagnetic alternating field, and
processing the output signal by means of a lock-in amplifier.

2. The method according to claim 1, including using a measuring element wherein the electrical resistance of the measuring element changes in dependence on the changes of the electromagnetic alternating field.

3. The method according to claim 1, wherein, the measuring element used is at least one of a giant magnetoresistance (GMR) element and a spin-dependent tunneling (SDT) element.

4. The method according to claim 1, including using the input signal of the measuring element as a reference signal for the lock-in amplifier.

5. The method according to claim 1, including using the input signal of the measuring element as an excitation signal for the electromagnetic alternating field.

6. The method according to claim 1, including using a high-frequency signal is used as an input signal of the measuring element.

7. The method according to claim 6, wherein the high-frequency signal used is a signal with a frequency of more than 1 kHz.

8. The method according to claim 1, including using a burst signal as an input signal of the measuring element.

9. An apparatus for measuring magnetic properties of a document comprising a device adapted to generate an electromagnetic alternating field, a measuring element disposed in the electromagnetic alternating field for measuring changes of the electromagnetic alternating field, and a lock-in amplifier arranged to process an output signal of the measuring element, wherein the measuring element is adapted to convert an electrical input signal of the measuring element into the electrical output signal in dependence on the electromagnetic alternating field.

10. The apparatus according to claim 9, wherein the device for generating the electromagnetic alternating field and the measuring element are integrated in a measuring head.

11. The apparatus according to claim 9, wherein, a signal generator is adapted to supply the measuring element with the input signal and the lock-in amplifier with a reference signal.

12. The apparatus according to claim 11, wherein the signal generator is adapted to supply a signal for generating the electromagnetic alternating field.

13. The apparatus according to claim 12, wherein the reference signal and the signal for generating the electromagnetic alternating field are identical.

14. The apparatus according to claim 11, wherein the signal generator is adapted to generate a high-frequency signal.

15. The apparatus according to claim 14, wherein the signal generator is adapted to generate a signal with a frequency of more than 1 kHz.

16. The apparatus according to claim 11, wherein the signal generator is a burst generator.

17. The apparatus according to claim 11, wherein the signal generator is integrated in the lock-in amplifier.

18. The apparatus according to claim 9, wherein the measuring element is at least one of a giant magnetoresistance (GMR) element and a spin-dependent tunneling (SDT) element.

19. The apparatus according to claim 9, wherein the device for generating the electromagnetic alternating field comprises two parallel coil cores which are connected with each other at one end, at least one coil being disposed on each of the two parallel coil cores.

20. A measuring head for measuring changes of a magnetic field, comprising:
at least one exciting coil arranged to generate a magnetic field, and
at least one of a giant magnetoresistance (GMR) element and a spin-dependent tunneling (SDT) element arranged to measure changes of the magnetic field, wherein the at least one exciting coil (14) and the giant magnetoresistance (GMR) or spin-dependent tunneling (SDT) element are disposed on a printed circuit board.

21. The measuring head according to claim 20, wherein the printed circuit board is disposed between two elements which are adapted to concentrate the flux of the magnetic field.

22. The measuring head according to claim 20, wherein the at least one exciting coil is disposed on the printed circuit board in the form of a multilayer printed coil.

23. The measuring head according to claim 20, wherein an evaluation electronics adapted to evaluate output signals of the GMR or SDT element is disposed on the printed circuit board.

24. The measuring head according to claim 23, wherein the evaluation electronics comprises a lock-in amplifier.
